(19) United States
(12) Patent Application Publication
(10) Pub. No.: US 2006/0243571 A1
(43) Pub. Date: Nov. 2, 2006

(54) Ignition switch of gas stove

(75) Inventor: Sen-Yu Wu, Taichung Hsien (TW)

Correspondence Address: BRUCE H. TROXELL, SUITE 1404, 5205 LEESBURG PIKE, FALLS CHURCH, VA, 22041, US

(73) Assignee: Seven Universe Industrial Co., Ltd.

(21) Appl. No.: 11/115,287

(22) Filed: Apr. 27, 2005

(51) Int. Cl. H01H 9/06

(52) U.S. Cl. 200/61.86

(57) ABSTRACT

An ignition switch has a switch member, a closed device, a knob assembly, a terminal switch and a driving device. The switch member has an opening. The terminal switch has a conductive end inserted into the opening of the switch member. The driving device has a conductive portion and an insulating portion to touch the conductive end of the terminal switch. The driving device is turned by the knob assembly to select the conductive portion or the insulating portion to touch the conductive end of the terminal switch.

### BACKGROUND OF THE INVENTION

1. Field of the Invention

The present invention relates generally to a gas stove and more particularly to an ignition switch of the gas stove.

2. Description of the Related Art

To burn the gas rapidly, the gas stove usually is provided with a micro-switch electrically connected to the ignition device and a plate on the axle of the knob. The micro-switch is activated when the knob is turned to make sure the ignition device burning gas. It improves the conventional stove having to start the ignition device several times for burning gas.

The gas stove with the micro-switch further is provided with a frame outside the stove to install the micro-switch, such that the size of the stove is bigger. The designer is hard to change the structure of the stove.

### SUMMARY OF THE INVENTION

The primary objective of the present invention is to provide an ignition switch of a gas stove, which is provided with the micro-switch but without having to increase the size of the stove.

According to the objective of the present invention, an ignition switch comprises a switch member, a closed device, a knob assembly, a terminal switch and a driving device. The switch member has an opening. The terminal switch has a conductive end inserted into the opening of the switch member. The driving device has a conductive portion and an insulating portion to touch the conductive end of the terminal switch. The driving device is turned by the knob assembly to select the conductive portion or the insulating portion to touch the conductive end of the terminal switch.

### BRIEF DESCRIPTION OF THE DRAWINGS

FIG. 1 is an exploded view in parts of a first preferred embodiment of the present invention;

FIG. 2 and FIG. 3 are sketch diagrams of the first preferred embodiment of the present invention, showing the operation of the driving device;

FIG. 4 is a sectional view of a second preferred embodiment of the present invention, and

FIG. 5 and FIG. 6 are sketch diagrams of the second preferred embodiment of the present invention, showing the operation of the driving device.

### DETAILED DESCRIPTION OF THE INVENTION

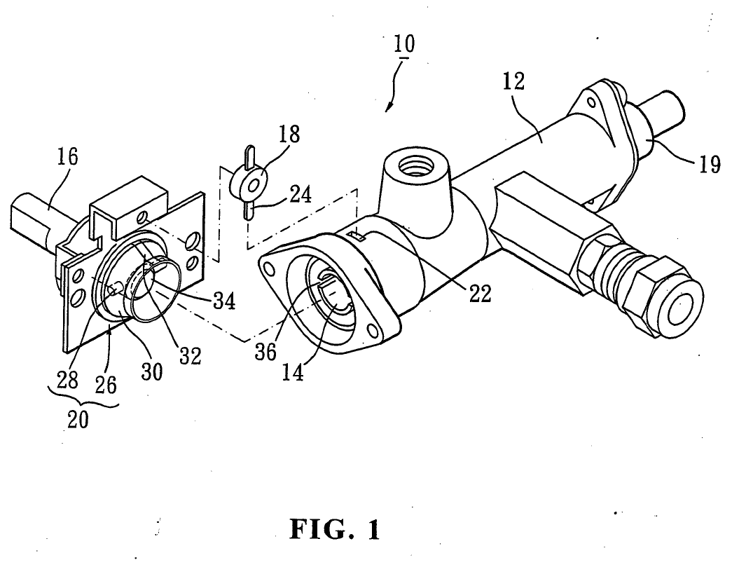

As shown in FIG. 1, an ignition switch 10 of the first preferred embodiment of the present invention comprises a switch member 12, a closed device 14, a knob assembly 16, a connecting device 18, a relay 19 and an ignition device (not shown). These elements are as same as the conventional devices, so I'll not describe the detail. The characters of the present invention are described hereunder:

The switch member 12 has an opening 22. The terminal switch 18 is outside of the switch member 12 with a conductive end 24 inserted into the opening 22.

A driving device 20 has a connecting member 16 and a post 28. The connecting member 16 has a conductive portion 30, which is a barrel element and is made of a conductive material, and an insulating portion 32, which is an elongated insulating material on the conductive portion 30. The post 28 is received in the conductive portion 30 and is pivoted on an end of a shaft 34 of the knob assembly 16. The post 28 is engaged with a slot 36 on the closed device 14 to fit the connecting member 26 to the closed device 14. As a result, turning the knob assembly 16 can move the closed device 14.

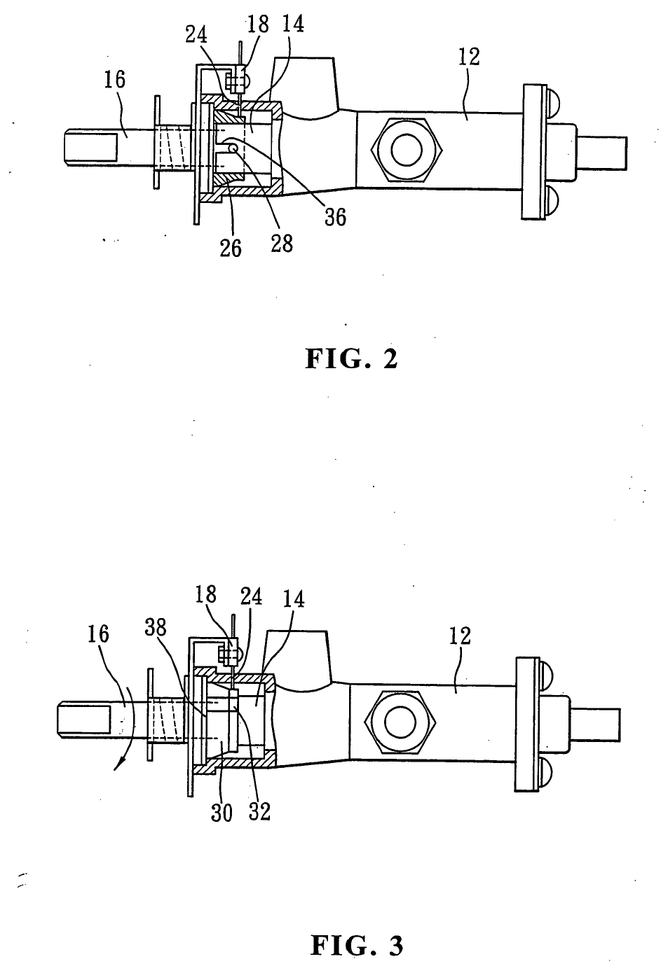

As shown in FIG. 2, at initial, the insulating portion 32 of the driving device 20 touches the conductive end 24 of the terminal switch 18, such that the terminal switch 18 is not electrically connected to the driving device 20, and the ignition device is not started. While the knob assembly 16 is turned, the driving device 20 is turned by the shaft 34 to drive the closed device 14 turning. In the meantime, the conductive portion 30 of the driving device 20 is turned to touch the conductive end 24 of the terminal switch 18, as shown in FIG. 3. As a result, the terminal switch 18 is electrically connected to the driving device 20 to form a circuit and to start the ignition device.

The present invention provides the driving device 20 connecting the shaft 34 and the closed device 14 to driving the closed device 14 turning and to connect or disconnect the terminal switch 18 to control the ignition device. As a result, the ignition switch of the present invention can burn gas in one ignition, and furthermore, the driving device 20 and the closed device 14 are in a firm connection for simultaneous turning.

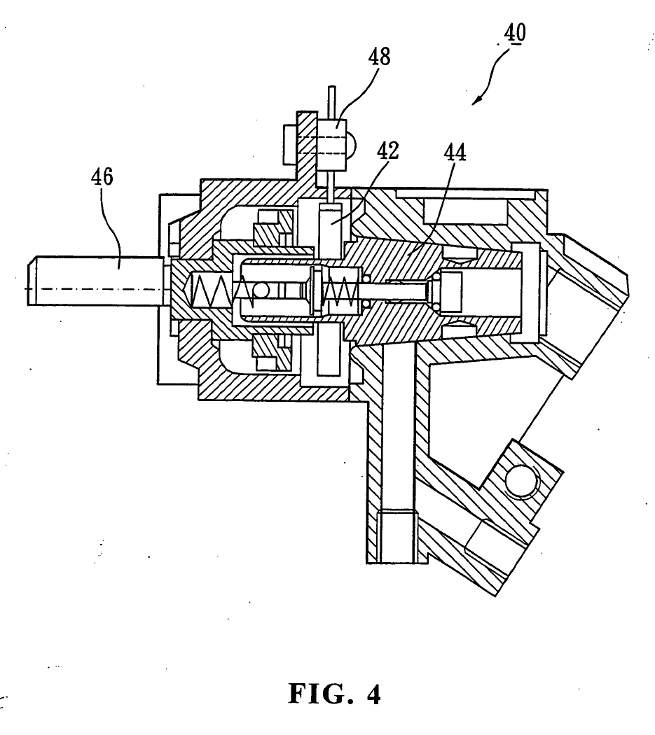

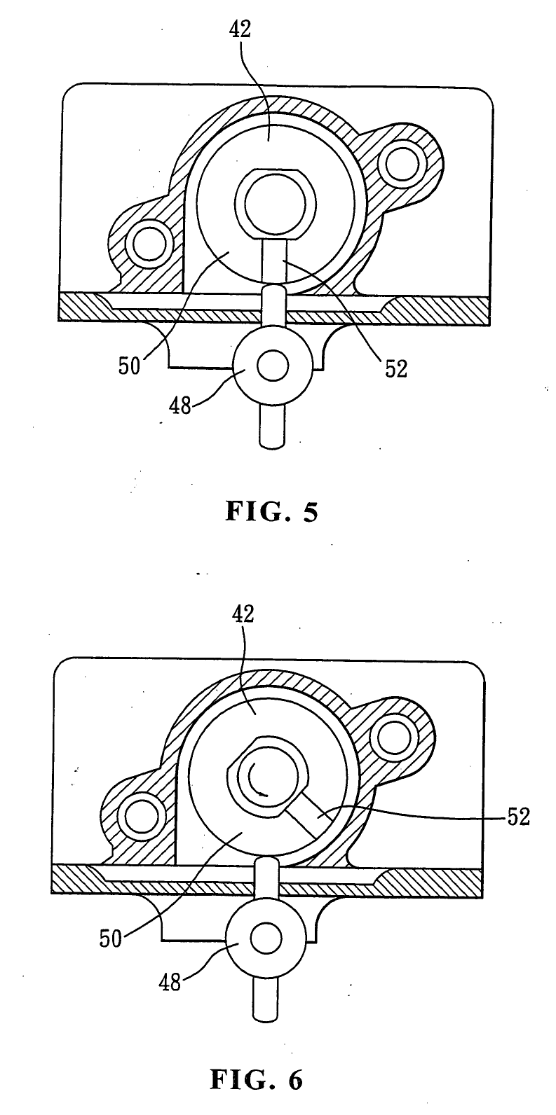

FIGS. 4 to 6 show an ignition switch 40 of the second preferred embodiment of the present invention, which is similar to the ignition switch 10 of the first preferred embodiment, except that a driving device 42 is fitted to the closed device 44 at an end thereof connecting to a knob assembly. The driving device 42 has a disk-like conductive portion 50 and an elongated insulating portion 52 on the conductive portion 50 along a radial direction. The ignition switch 40 of the second preferred embodiment has all the functions above.

1. An ignition switch, comprising a switch member, a closed device, a knob assembly, a terminal switch and a driving device; the switch member having an opening; the terminal switch having a conductive end inserted into the opening of the switch member; the driving device having a conductive portion and an insulating portion to touch the conductive end of the terminal switch, wherein the driving device is turned by the knob assembly to select the conductive portion or the insulating portion to touch the conductive end of the terminal switch, wherein the driving device has a connecting member pivoted on an end of a shaft of the knob assembly, on which the conductive portion and the insulating portion are provided.

2. The ignition switch as defined in claim 1, wherein the driving device connects the knob assembly and the closed device.

3. (canceled)

4. The ignition switch as defined in claim 1, wherein the driving device further has a post to pivot the connecting member on the shaft of the knob assembly, and the post is engaged with a slot on an end of the closed device.

5. The ignition switch as defined in claim 1, wherein the insulting portion is an elongated section on the connecting member parallel to the shaft of the knob assembly.

6. The ignition switch as defined in claim 5, wherein the connecting member is a barrel-like element, which is made of a conductive material to be the conductive portion, and the insulating portion is an insulating material on the conductive portion.

7. The ignition switch as defined in claim 2, wherein the driving device is fitted to the closed device at an end of the closed device connecting to the knob assembly.

8. The ignition switch as defined in claim 7, wherein the driving portion is a disk-like element, which is made of a conductive material to be the conductive portion, and the insulating portion is an insulating material on the conductive portion along a radial direction.
